(19) United States
(12) Patent Application Publication
(10) Pub. No.: US 2024/0419157 A1
(43) Pub. Date: Dec. 19, 2024

(54) RECORDING MEDIUM, NORMAL MODEL GENERATION APPARATUS, AND NORMAL MODEL GENERATION METHOD

(71) Applicant: Mitsubishi Electric Corporation, Tokyo (JP)

(72) Inventors: Toshiyuki HATTA, Tokyo (JP); Wataru FUJITA, Tokyo (JP); Shota NAKANO, Tokyo (JP)

(73) Assignee: Mitsubishi Electric Corporation, Tokyo (JP)

(21) Appl. No.: 18/713,184

(22) PCT Filed: Jun. 27, 2022
(86) PCT No.: PCT/JP2022/025612

§ 371 Date: May 24, 2024

(51) Int. Cl. G05B 23/02; G06N 20/00

(52) U.S. Cl. CPC G05B 23/0224; G06N 20/00; G05B 2223/06

(57) ABSTRACT

A normal model generation program stored in a non-transitory computer-readable recording medium is executable by a computer for acquiring time series sensor data generated by a sensor detecting a state of an operation subject performing repetitive tasks including a series of plurality of modes. The program causes the computer to function as a mode divider to generate mode data including the sensor data being divided by mode-division, a cycle divider to generate, based on the mode data, cycle data indicating cycle sections, a cycle determiner to determine a normal cycle section based on the cycle data and the mode data, and a normal model generator to generate a normal model for each of the plurality of modes based on mode data included in the normal cycle section.

### TECHNICAL FIELD

The present disclosure relates to a normal model generation program, a normal model generation apparatus, and a normal model generation method.

### BACKGROUND ART

One method for detecting an anomaly in an operation subject such as equipment, an operator, or a work robot includes comparing time series sensor data indicating any detected state of the operation subject with normal sensor data collected when the operation subject is in a normal state. For example, Patent Literature 1 describes a device that detects an anomaly by dividing, based on event signals from equipment for each mode, sensor data that is output from the equipment having multiple modes for different operating states, and comparing the resultant sensor data with a normal model trained with data selected for each mode. Dividing data for each mode is hereafter referred to as mode-division.

### CITATION LIST

### Patent Literature

Patent Literature 1: Unexamined Japanese Patent Application Publication No. 2015-172945

### SUMMARY OF INVENTION

### Technical Problem

In training a normal model with training data including abnormal data with the technique described in Patent Literature 1, normal data is selected for each mode by comparing feature vectors for each mode, causing a high computational load.

In response to the above issue, an objective of the present disclosure is to reduce the computational load in training a normal model for each mode by performing mode-division of time series sensor data indicating any detected state of an operation subject that is performing tasks having multiple modes.

### Solution to Problem

To achieve the above objective, a normal model generation program according to an aspect of the present disclosure is executable by a computer for acquiring time series sensor data generated by a sensor detecting a state of an operation subject performing repetitive tasks including a series of plurality of modes. The program causes the computer to function as a mode divider, a cycle divider, a cycle determiner, and a normal model generator. The mode divider generates mode data including the sensor data being divided by mode-division. The cycle divider generates, based on the mode data, cycle data indicating cycle sections in which the series of plurality of modes are repeated. The cycle determiner determines a normal cycle section based on the cycle data and the mode data. The normal model generator generates a normal model for each of the series of plurality of modes based on mode data included in the normal cycle section.

### Advantageous Effects of Invention

The technique according to the above aspect of the present disclosure can reduce the computational load in training the normal model for each mode by performing mode-division of the time series sensor data indicating any detected state of the operation subject that is performing the tasks having the multiple modes and by generating the normal model based on the mode data included in the normal cycle sections.

### BRIEF DESCRIPTION OF DRAWINGS

FIG. 1 is a functional block diagram of a normal model generation apparatus according to an embodiment;

FIG. 2 is a diagram of example sensor data in the embodiment;

FIG. 3 is a diagram of example mode data generated when a normal model is not stored in the embodiment;

FIG. 4 is a diagram of example mode data generated when the normal model is stored in the embodiment;

FIG. 5 is a diagram of example cycle data in the embodiment;

FIG. 6 is a diagram of example determination result data in the embodiment;

FIG. 7 is a diagram of example templates included in the normal model in the embodiment;

FIG. 8 is a diagram illustrating example thresholds included in the normal model in the embodiment;

FIG. 9 is a diagram of example anomaly detection result data in the embodiment;

FIG. 10 is a flowchart of a learning process in the embodiment;

FIG. 11 is a flowchart of an anomaly detection process in the embodiment;

FIG. 12 is a block diagram of the normal model generation apparatus according to the embodiment, illustrating an example hardware configuration;

FIG. 13A is a functional block diagram of a learning device according to a modification; and

FIG. 13B is a functional block diagram of an anomaly detection device according to the modification.

### DESCRIPTION OF EMBODIMENTS

A normal model generation program, a normal model generation apparatus, and a normal model generation method according to the present embodiment are described below in detail with reference to the drawings. In the drawings, the same reference signs denote the same or corresponding components. In the example described in the present embodiment, an anomaly is detected based on time series sensor data generated by sensors detecting the state of an operation subject that is performing repetitive tasks having a series of multiple modes. The series of multiple modes includes a predetermined number of modes in a predetermined order. The operation subject may be one or more machines, one or more persons, or any combination of these.

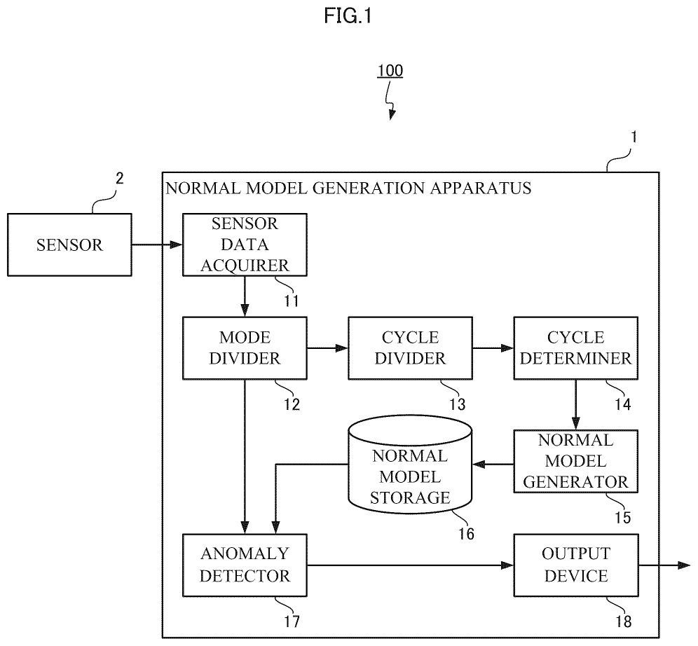

As illustrated in FIG. 1, an anomaly detection system 100 includes a sensor 2 that detects the state of the operation subject that is performing the repetitive tasks having the series of multiple modes, and a normal model generation apparatus 1 that detects an anomaly based on time series sensor data generated by the sensor 2. The normal model generation apparatus 1 includes a sensor data acquirer 11 that acquires the sensor data from the sensor 2, a mode divider 12 that generates mode data including the sensor data being divided for each mode, a cycle divider 13 that generates, based on the mode data, cycle data indicating cyclic sections in which the series of multiple modes is repeated, a cycle determiner 14 that determines a normal cyclic section based on the cycle data and the mode data, and a normal model generator 15 that generates a normal model based on the mode data included in the normal cyclic section. Dividing the sensor data for each mode is hereafter referred to as mode-division. The cyclic sections in which the series of multiple modes is repeated are hereafter referred to as cycle sections.

The normal model generation apparatus 1 also includes a normal model storage 16 storing the normal model, an anomaly detector 17 that detects an anomaly for each section in the mode data based on the mode data and the normal model and generates anomaly detection data indicating sections in the mode data in which an anomaly is detected, and an output device 18 that outputs the anomaly detection data.

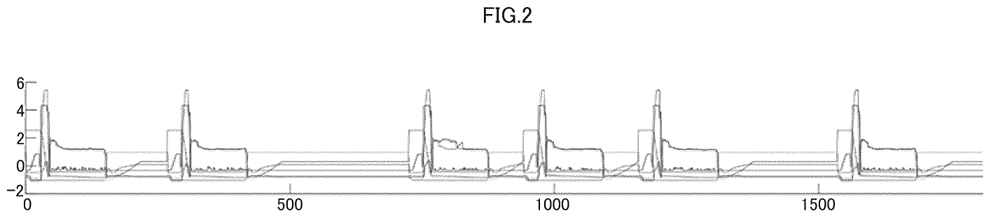

The sensor data acquired by the sensor data acquirer 11 from the sensor 2 is described with reference to FIG. 2. The sensor data is, for example, data about physical quantities acquired by the sensor 2 detecting the state of the operation subject, and includes temperature, pressure, speed, voltage, and movement. One or more sensors that detect the state of the operation subject are used as the sensor 2. Sensor data acquired from a single sensor is one-dimensional time series data, whereas sensor data acquired from multiple sensors is multi-dimensional time series data. In the example in FIG. 2, the sensor data is seven-dimensional time series data. In the graph in FIG. 2, the vertical axis indicates the physical quantity value, and the horizontal axis indicates time. The physical quantity values are standardized to a mean value of 0 and a standard deviation of 1 for each dimension.

Referring back to FIG. 1, the sensor data acquirer 11 transmits the acquired sensor data to the mode divider 12. The mode divider 12 performs mode-division of the sensor data received from the sensor data acquirer 11 to generate mode data. The mode divider 12 generates mode data by periodically assigning the series of multiple modes to the sections resulting from the sensor data being divided.

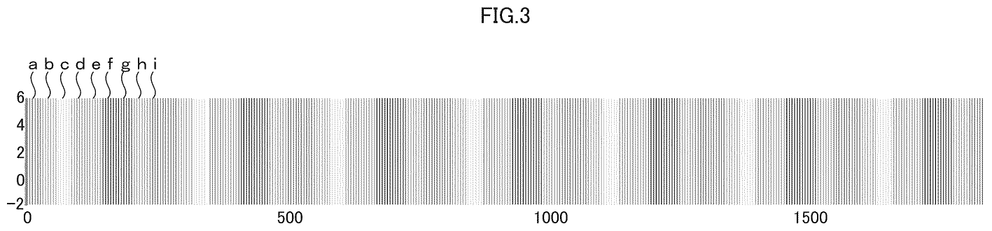

The mode data generated by the mode divider 12 when the normal model storage 16 does not store the normal model is described with reference to FIG. 3. When the normal model storage 16 does not store the normal model, the mode divider 12 performs mode-division of the sensor data using predetermined parameters to generate mode data.

The mode divider 12 uses, as predetermined parameters, for example, an expected cycle length as the length (time) expected for one cycle, and the number of modes included in one cycle. The mode divider 12 calculates an expected mode length as the length (time) expected for one mode by dividing the expected cycle length by the number of modes. The mode divider 12 generates mode data by dividing the sensor data into multiple sections each having the expected mode length and periodically assigning the series of multiple modes to the multiple sections. In the example in FIG. 3, nine modes a to i are periodically assigned to the sections resulting from the sensor data being divided by the expected mode length. In FIG. 3, the modes a to i are represented by shades, and each section with a mode in the mode data includes sensor data.

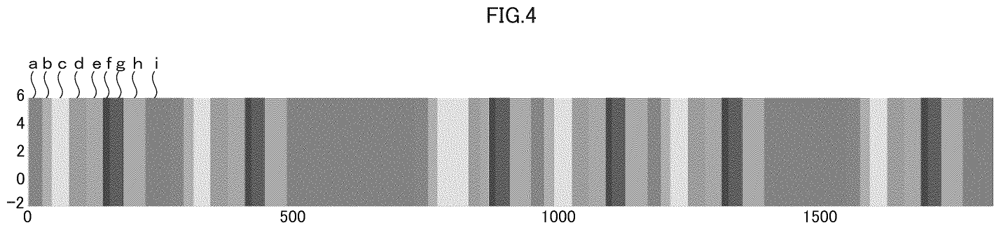

The mode data generated by the mode divider 12 when the normal model storage 16 stores the normal model is described with reference to FIG. 4. When the normal model storage 16 stores the normal model, the mode divider 12 performs mode-division of the sensor data by comparing the sensor data with a template for each mode included in the normal model to generate mode data. The normal model is described in detail later.

The mode divider 12 divides the sensor data into the multiple sections based on the template for each mode included in the normal model using, for example, Forward filtering-Backward sampling (FF-BS), and classifies the sensor data in each of the divided sections into the corresponding mode to generate mode data. The mode data generation method using FF-BS is described in detail in, for example, paragraphs 0036 to 0040 in International Publication No. WO2019/229943 with the class data sequence corresponding to the mode data. In the example in FIG. 4, the corresponding nine modes a to i are periodically assigned to the sections resulting from the sensor data being divided using FF-BS. In FIG. 4, the modes a to i are represented by shades, and each section with a mode in the mode data includes sensor data, as in FIG. 3.

The mode divider 12 can perform mode-division of the sensor data using the normal model even when event signals from the operation subject are not available.

With a typical mode data (class data sequence) generation method using FF-BS, every combination of two modes assigned to adjacent sections is to be considered. For example, mode data with the nine modes a to i are to be generated. When the mode a is assigned to a section, each of the nine modes a to i can be assigned to a subsequent section. In the present embodiment, the nine modes a to i are periodically assigned in the mode data. Thus, when the mode a is assigned to a section, for example, the mode b is assigned to a subsequent section. In other words, the combination of two modes that can be assigned to adjacent sections is determined. This greatly reduces the computational load on the mode divider 12.

Referring back to FIG. 1, the mode divider 12 transmits the generated mode data to the cycle divider 13 and the anomaly detector 17. The cycle divider 13 identifies the cycle sections in the sensor data based on the mode data received from the mode divider 12. The cycle divider 13 generates cycle data indicating the identified cycle sections.

The cycle divider 13 first calculates, for each of the multiple modes included in the mode data, a coefficient of variation of the length (time) of each section with the mode being assigned. The coefficient of variation is the standard deviation divided by the mean value. The cycle divider 13 then detects, of the multiple modes, a mode with the greatest calculated coefficient of variation and exceeding a predetermined reference value as an inactive mode. The above method for detecting an inactive mode is used when the lengths of the multiple sections with a specific mode being assigned are reproducible during operation (with less varying lengths of the sections), but not reproducible in an inactive state in which no operation is performed (with largely varying lengths of the sections). The method for detecting an inactive mode is not limited to the above method. For example, for the sensor data with values that do not change when the operation subject is inactive, an inactive mode may be detected based on the changing values of the sensor data. More specifically, the mode assigned to sections in which the values of the sensor data do not change is detected as an inactive mode. For the sensor data reproducible when the operation subject is inactive, an inactive mode may be detected by comparing the sensor data with a pre-generated template for the inactive mode.

When detecting an inactive mode, the cycle divider 13 identifies the cycle sections with the end time of the sections with the identified inactive mode being assigned in the mode data as the time to switch the cycle sections. When detecting no inactive mode, the cycle divider 13 selects a predetermined mode and identifies the cycle sections with the end time of the sections with the predetermined mode being assigned as the time to switch the cycle sections.

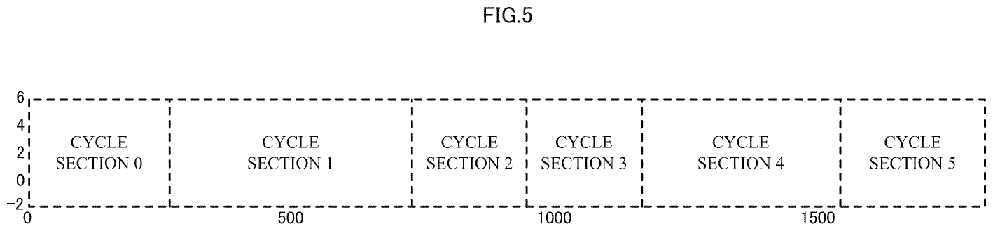

The cycle data generated by the cycle divider 13 is described with reference to FIG. 5. In the cycle data in FIG. 5, cycle sections 0 to 5 are identified for the mode data in FIG. 4 with the mode i detected as an inactive mode.

Referring back to FIG. 1, the cycle divider 13 transmits the mode data and the generated cycle data to the cycle determiner 14. The cycle determiner 14 determines normal cycle sections based on the mode data and the cycle data received from the cycle divider 13. The cycle determiner 14 first divides the mode data into the cycle sections based on the cycle data. The cycle determiner 14 then determines whether each cycle section is normal or abnormal based on the multiple pieces of mode data divided into the cycle sections. The cycle determiner 14 determines a cycle section satisfying a predetermined determination condition to be normal.

The determination condition is that the lengths of the sections each with a piece of mode data in a cycle section all fall within standard ranges set for the respective modes. The standard range can be set as, for example, a deviation value of 30 to 70 inclusive or the 30 to 70th percentile inclusive based on the lengths of the multiple sections with the mode being assigned. The standard range is not applied to the mode identified as an inactive mode.

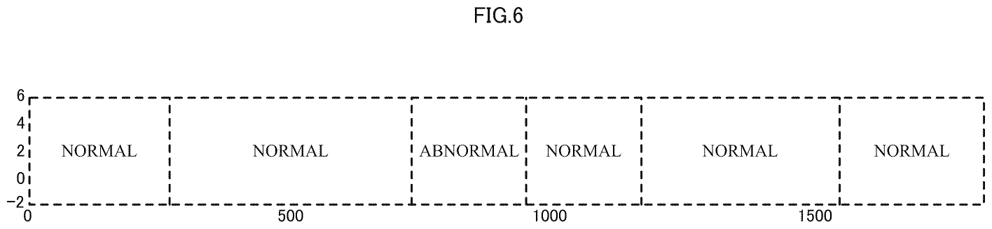

The cycle determiner 14 generates determination result data indicating whether each cycle section is normal or abnormal. The determination result data generated by the cycle determiner 14 is described with reference to FIG. 6. The determination result data in FIG. 6 is acquired by dividing the mode data in FIG. 4 into the cycle sections using the cycle data illustrated in FIG. 5, and determining whether each cycle section is normal or abnormal based on the multiple pieces of mode data divided into the cycle section. For example, in the cycle section 2, the length of the section with the mode c does not fall within the standard range. The cycle section 2 is thus determined to be abnormal.

Referring back to FIG. 1, the cycle determiner 14 transmits the mode data, the cycle data, and the generated determination result data to the normal model generator 15. The normal model generator 15 generates a normal model based on the cycle data received from the cycle determiner 14 and the mode data included in the normal cycle sections indicated by the determination result data, and stores the normal model into the normal model storage 16. The normal model storage 16 may be included in an external device or an external system.

The mode divider 12, the cycle divider 13, the cycle determiner 14, and the normal model generator 15 repeat the above processing to train the normal model. The normal model generator 15 stops generating the normal model when the generated normal model satisfies a predetermined learning end condition. The learning end condition is that, for example, the learning model generated by the normal model generator 15 matches the normal model stored in the normal model storage 16. Matching herein may not be matching exactly, and may be, for example, matching with a similarity greater than or equal to a predetermined value. The learning end condition is not limited to the above condition, and may be defined by the number of times the mode divider 12, the cycle divider 13, the cycle determiner 14, and the normal model generator 15 repeat the above processing.

More specifically, the normal model generator 15 uses Gaussian process regression to calculate a template being a parameter of a Gaussian distribution of the sensor data in the sections classified into each mode. The template calculation method using Gaussian process regression is described in detail in, for example, paragraphs 0030 to 0035 in International Publication No. WO2019/229943 with the standard pattern corresponding to the template. The normal model generator 15 also calculates multiple thresholds corresponding to the respective modes based on the lengths of the multiple sections classified into the respective modes. For example, the normal model generator 15 can calculate statistics such as a mean value, a percentile value, and a deviation value of the lengths of the multiple sections classified into the respective modes as a threshold. The sections with a mode identified as an inactive mode do not undergo anomaly detection. No threshold is thus set for the mode. The normal model generator 15 stores the templates and the thresholds corresponding to the respective multiple modes as a normal model into the normal model storage 16.

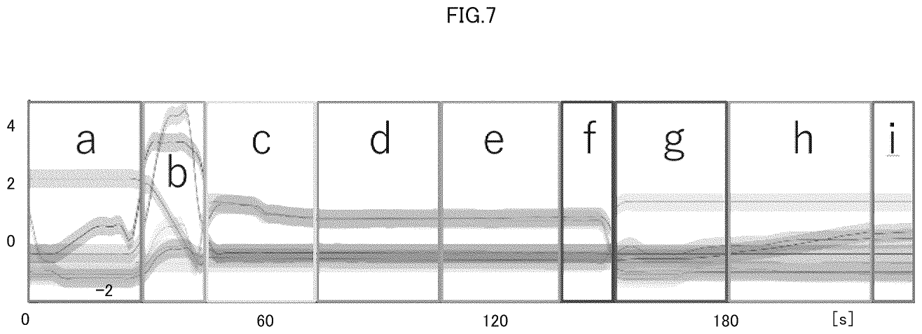

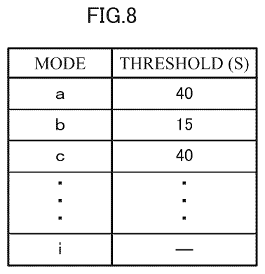

The normal model stored in the normal model storage 16 is described with reference to FIGS. 7 and 8. FIG. 7 illustrates an example template corresponding to each of the multiple modes included in the normal model. The template is a parameter of the Gaussian distribution of the sensor data in the section classified into each mode. More specifically, the template is calculated as the mean value and the variance of the sensor data at each time in the section classified into each mode. The example in FIG. 7 illustrates the templates in a time series graph. FIG. 8 illustrates example thresholds included in the normal model. In the example in FIG. 8, each threshold is the mean value of the lengths of the multiple sections with the corresponding mode being assigned. A threshold is not set for the mode i identified as an inactive mode. Although a single threshold is set for each mode in FIG. 8, thresholds indicating a lower limit and an upper limit may be set.

Referring back to FIG. 1, the anomaly detector 17 detects an anomaly for each section in the mode data based on the mode data received from the mode divider 12 and the normal model stored in the normal model storage 16. The anomaly detector 17 compares the length of each section in the mode data with the threshold in the normal model corresponding to the mode assigned to each section, and determines whether each section is abnormal based on whether the length of each section exceeds the threshold. In some embodiments, the anomaly detector 17 may compare the sensor data included in each section in the mode data with the template in the normal model corresponding to the mode assigned to each section, and detect an anomaly using a similarity as an anomaly measure. In some embodiments, the anomaly detector 17 may perform comparison with both the thresholds and the templates and determine whether each section is abnormal. When the anomaly detector 17 does not use the thresholds to detect an anomaly, the normal model may not include the thresholds.

The anomaly detector 17 does not detect an anomaly for the sections with the inactive mode being assigned. This can reduce anomaly detection (false detection) that may occur when the operation subject is inactive, thus reducing the likelihood of the performance of anomaly detection being lowered. When detecting an anomaly in a section in the mode data, the anomaly detector 17 generates anomaly detection data indicating the section in the mode data with the detected anomaly.

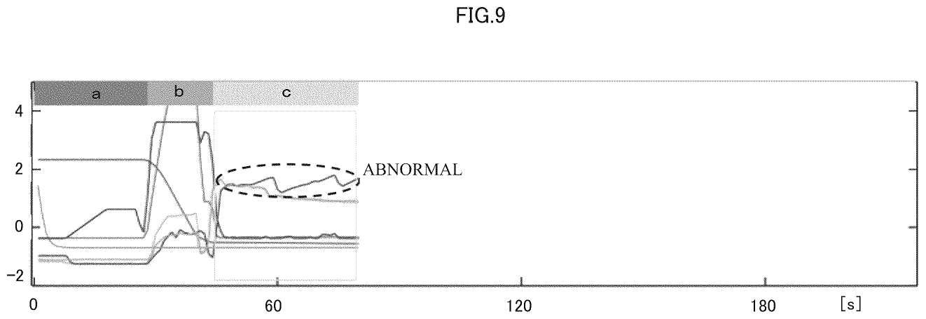

The anomaly detection data generated by the anomaly detector 17 is described with reference to FIG. 9. In the example in FIG. 9, the length of the section with the mode c in the mode data exceeds the threshold. The section with the mode c is thus detected as being abnormal. Although the anomaly detector 17 detects an anomaly based on the lengths (time) of the sections included in the mode data alone in the example in FIG. 9, the anomaly detector 17 may detect an anomaly using a similarity between the sensor data included in each section in the mode data and the template as an anomaly measure.

Referring back to FIG. 1, the anomaly detector 17 transmits the generated anomaly detection data to the output device 18. The output device 18 outputs the anomaly detection data received from the anomaly detector 17. The anomaly detection data may be output, for example, on a display screen or using sounds. The anomaly detection data may be transmitted to a user terminal used by a user.

As described above, the processing performed by the normal model generation apparatus 1 includes a learning phase in which the normal model is trained based on the sensor data and an anomaly detection phase in which an anomaly is detected and output based on the sensor data.

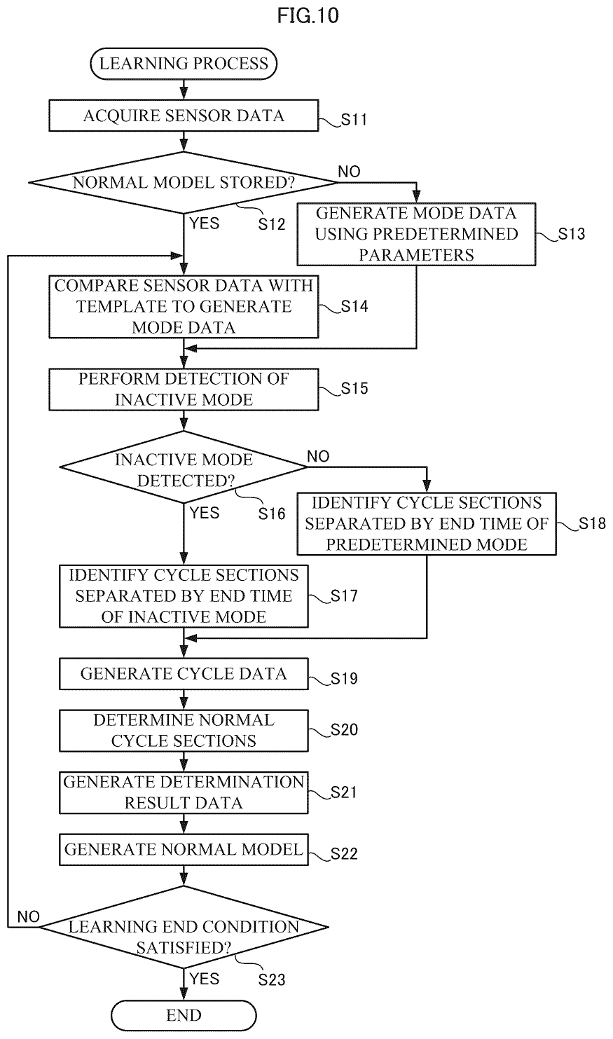

A learning process performed by the normal model generation apparatus 1 in the learning phase is described with reference to FIG. 10. The learning process illustrated in FIG. 10 starts when the normal model generation apparatus 1 is switched to the learning phase. The sensor data acquirer 11 acquires sensor data from the sensor 2 (step S11). The sensor data acquirer 11 acquires the sensor data in a batch in batch processing. The sensor data acquirer 11 transmits the acquired sensor data to the mode divider 12.

For example, the sensor data in FIG. 2 is the seven-dimensional time series data indicating the physical quantities acquired by the sensor 2 detecting the state of the operation subject. In the graph in FIG. 2, the vertical axis indicates the physical quantity value, and the horizontal axis indicates time. The physical quantity values are standardized to a mean value of 0 and a standard deviation of 1 for each dimension.

Referring back to FIG. 10, when the normal model storage 16 does not store a normal model (No in step S12), the mode divider 12 performs mode-division of the sensor data received from the sensor data acquirer 11 using predetermined parameters to generate mode data (step S13).

FIG. 3 illustrates example mode data generated in step S13. The mode divider 12 uses, as predetermined parameters, for example, an expected cycle length as the length (time) expected for one cycle, and the number of modes included in one cycle. The mode divider 12 calculates an expected mode length as the length (time) expected for one mode by dividing the expected cycle length by the number of modes. In the example in FIG. 3, the mode divider 12 periodically assigns the nine modes a to i to the sections resulting from the sensor data being divided by the expected mode length. Although not illustrated, each section with a mode in the mode data includes sensor data.

When the normal model storage 16 stores a normal model (Yes in step S12), the mode divider 12 performs mode-division of the sensor data received from the sensor data acquirer 11 by comparing the sensor data with a template for each mode included in the normal model to generate mode data (step S14). The mode divider 12 transmits the generated mode data to the cycle divider 13.

FIG. 4 illustrates example mode data generated in step S14. The mode divider 12 divides the sensor data into multiple sections based on the template for each mode included in the normal model using, for example, FF-BS, and classifies the sensor data in each of the divided sections into the corresponding mode to generate mode data. In the example in FIG. 4, the mode divider 12 periodically assigns the corresponding nine modes a to i to the sections resulting from the sensor data being divided using FF-BS. Although not illustrated, each section with a mode in the mode data includes sensor data.

Referring back to FIG. 10, the cycle divider 13 performs detection of an inactive mode of the multiple modes included in the mode data (step S15). When the cycle divider 13 detects an inactive mode (Yes in step S16), the cycle divider 13 identifies cycle sections separated by the end time of the inactive mode using the end time of the sections with the detected inactive mode being assigned in the mode data as the time to switch the cycle sections (step S17). When the cycle divider 13 does not detect an inactive mode (No in step S16), the cycle divider 13 selects a predetermined mode and identifies cycle sections separated by the end time of the predetermined mode using the end time of the sections with the predetermined mode being assigned in the mode data as the time to switch the cycle sections (step S18). The cycle divider 13 generates cycle data indicating the identified cycle sections (step S19). The cycle divider 13 transmits the mode data and the generated cycle data to the cycle determiner 14.

In the cycle data in FIG. 5, for example, the cycle sections are identified for the mode data in FIG. 4 with the mode i detected as an inactive mode.

Referring back to FIG. 10, the cycle determiner 14 determines normal cycle sections based on the mode data and the cycle data received from the cycle divider 13 (step S20). In step S20, the cycle determiner 14 determines a cycle section satisfying a determination condition that the lengths of the sections each with a piece of mode data in a cycle section all fall within standard ranges set for the respective modes to be a normal section. The cycle determiner 14 generates determination result data indicating whether each cycle section is normal or abnormal (step S21). The cycle determiner 14 transmits the mode data, the cycle data, and the generated determination result data to the normal model generator 15.

For example, the determination result data in FIG. 6 is acquired by dividing the mode data in FIG. 4 into the cycle sections using the cycle data in FIG. 5, and determining whether each cycle section is normal or abnormal based on the multiple pieces of mode data divided into the cycle sections.

Referring back to FIG. 10, the normal model generator 15 generates a normal model based on the cycle data and the mode data included in the normal cycle sections indicated by the determination result data (step S22).

More specifically, the normal model generator 15 uses Gaussian process regression to calculate a template being a parameter of a Gaussian distribution of the sensor data in the sections classified into each mode. The normal model generator 15 also calculates multiple thresholds corresponding to the respective modes based on the lengths of the multiple sections classified into the respective modes. For example, the normal model generator 15 can calculate statistics such as a mean value, a percentile value, and a deviation value of the lengths of the multiple sections classified into the respective modes as a threshold. The sections with a mode identified as an inactive mode do not undergo anomaly detection. No threshold is thus set for the mode. The normal model generator 15 stores the templates and the thresholds corresponding to the respective multiple modes as a normal model into the normal model storage 16.

The normal model stored in the normal model storage 16 is described with reference to FIGS. 7 and 8. FIG. 7 illustrates an example template corresponding to each of the multiple modes included in the normal model. In the example in FIG. 7, the template is a parameter of the Gaussian distribution of the sensor data in the section classified into each mode. More specifically, the template is calculated as the mean value and the variance of the sensor data at each time in the section classified into each mode. FIG. 8 illustrates example thresholds included in the normal model. In the example in FIG. 8, each threshold is the mean value of the lengths of the multiple sections with the corresponding mode being assigned. A threshold is not set for the mode i identified as an inactive mode.

Referring back to FIG. 10, the normal model generator 15 determines whether a learning end condition is satisfied (step S23). The learning end condition is that, for example, the learning model generated by the normal model generator 15 matches the normal model stored in the normal model storage 16. When the learning end condition is not satisfied (No in step S23), the processing returns to step S14 and repeats steps S14 to S23. When the learning end condition is satisfied (Yes in step S23), the processing ends.

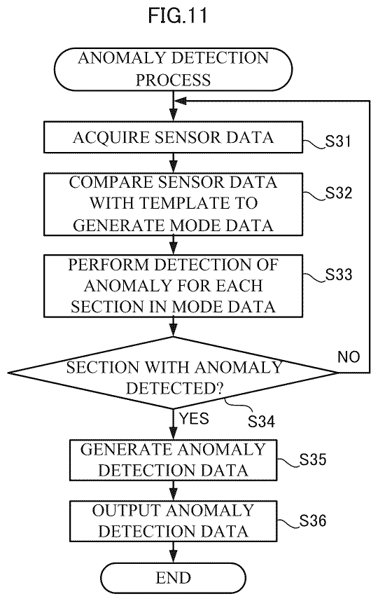

An anomaly detection process performed by the normal model generation apparatus 1 in the anomaly detection phase is described with reference to FIG. 11. The anomaly detection process illustrated in FIG. 11 starts when the normal model generation apparatus 1 is switched to the anomaly detection phase. The sensor data acquirer 11 acquires sensor data from the sensor 2 (step S31). The sensor data acquirer 11 sequentially acquires the sensor data from the sensor 2. The sensor data acquirer 11 transmits the acquired sensor data to the mode divider 12.

The mode divider 12 performs mode-division of the sensor data received from the sensor data acquirer 11 by comparing the sensor data with the template for each mode included in the normal model to generate mode data (step S32). The mode divider 12 transmits the generated mode data to the anomaly detector 17.

The anomaly detector 17 performs detection of an anomaly for each section in the mode data based on the mode data received from the mode divider 12 and the normal model stored in the normal model storage 16 (step S33). In step S33, the anomaly detector 17 compares, for example, the length of each section in the mode data with the threshold in the normal model corresponding to the mode assigned to each section, and determines whether each section is abnormal based on whether the length of each section exceeds the threshold. In some embodiments, the anomaly detector 17 compares the sensor data included in each section in the mode data with the template in the normal model corresponding to the mode assigned to each section, and determines whether each section is abnormal. In some embodiments, the anomaly detector 17 may perform comparison with both the thresholds and the templates and determine whether each section is abnormal.

The anomaly detector 17 does not detect an anomaly for the sections with the inactive mode being assigned. This can reduce anomaly detection (false detection) that may occur when the operation subject is inactive, thus reducing the likelihood of the performance of anomaly detection being lowered.

When an anomaly is not detected in any sections in the mode data (No in step S34), the processing returns to step 31 and repeats steps S31 to S34. When an anomaly is detected in a section in the mode data (Yes in step S34), the anomaly detector 17 generates anomaly detection data indicating the section in the mode data with the detected anomaly (step S35).

The anomaly detection data generated by the anomaly detector 17 is described with reference to FIG. 9. In the example in FIG. 9, the section with the mode c in the mode data is detected as being abnormal.

Referring back to FIG. 11, the anomaly detector 17 transmits the generated anomaly detection data to the output device 18. The output device 18 outputs the anomaly detection data received from the anomaly detector 17 (step S36) and ends the processing.

In the flowchart in FIG. 11, when an anomaly is detected, the anomaly detection data is output and the processing ends. However, steps S31 to S36 may be repeated when an anomaly is detected. In this case, the processing ends when, for example, the normal model generation apparatus 1 is turned off or switched to the learning phase.

Although the anomaly detection process illustrated in FIG. 11 is performed after the learning process in FIG. 10 is performed in the example described above, this is not limitative. For example, after the normal model is initially stored into the normal model storage 16, the normal model may be updated by performing the learning process periodically or at a user-specified timing in parallel with the anomaly detection process.

The normal model generation apparatus 1 according to the embodiment can reduce the computational load in training the normal model for each mode by performing mode-division of the time series sensor data indicating any detected state of the operation subject that is performing the tasks having the multiple modes and by generating the normal model based on the mode data included in the normal cycle sections.

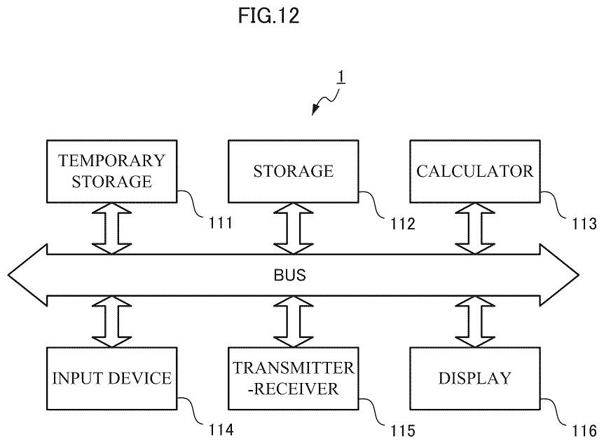

The hardware configuration of the normal model generation apparatus 1 is described with reference to FIG. 12. As illustrated in FIG. 12, the normal model generation apparatus 1 includes a temporary storage 111, a storage 112, a calculator 113, an input device 114, a transmitter-receiver 115, and a display 116. The temporary storage 111, the storage 112, the input device 114, the transmitter-receiver 115, and the display 116 are connected to the calculator 113 with a bus.

The calculator 113 is, for example, a central processing unit (CPU). The calculator 113 performs the processing of the mode divider 12, the cycle divider 13, the cycle determiner 14, the normal model generator 15, and the anomaly detector 17 in the normal model generation apparatus 1 in accordance with a control program stored in the storage 112.

The temporary storage 111 is, for example, a random-access memory (RAM). The control program stored in the storage 112 is loaded into the temporary storage 111, and the temporary storage 111 is used as a work area for the calculator 113.

The storage 112 is a nonvolatile memory such as a flash memory, a hard disk, a digital versatile disc RAM (DVD-RAM), or a DVD rewritable (DVD-RW). The storage 112 prestores the program for causing the calculator 113 to perform the processing of the normal model generation apparatus 1, provides data stored in the program to the calculator 113 in accordance with an instruction from the calculator 113, and stores data provided from the calculator 113. The normal model storage 16 is included in the storage 112.

The input device 114 includes an input device such as a keyboard and a pointing device, and an interface device that connects the input device, such as a keyboard and a pointing device, to the bus. Information input by the user is provided to the calculator 113 through the input device 114. In a structure in which the user switches between the learning phase and the anomaly detection phase of the normal model generation apparatus 1, the user inputs a switching instruction to the input device 114.

The transmitter-receiver 115 includes a network terminator or a radio communication device connected to a network, and a serial interface or a local area network (LAN) interface connected to the network terminator or the communication device. The transmitter-receiver 115 functions as the sensor data acquirer 11. In a structure in which the output device 18 transmits the anomaly detection data to the user terminal, the transmitter-receiver 115 functions as the output device 18.

The display 116 is, for example, a cathode ray tube (CRT) or a liquid crystal display (LCD). For example, the display 116 displays an operation screen for the user to input information. In the structure in which the user switches between the learning phase and the anomaly detection phase of the normal model generation apparatus 1, the display 116 displays a screen to input the switching instruction. In a structure in which the output device 18 displays the anomaly detection data on a screen, the display 116 functions as the output device 18.

The processing of the sensor data acquirer 11, the mode divider 12, the cycle divider 13, the cycle determiner 14, the normal model generator 15, the normal model storage 16, the anomaly detector 17, and the output device 18 in the normal model generation apparatus 1 illustrated in FIG. 1 is performed when the control program is executed using, for example, the temporary storage 111, the calculator 113, the storage 112, the input device 114, the transmitter-receiver 115, and the display 116 as resources.

The hardware configuration and the flowcharts are mere examples, and may be changed or modified as appropriate.

The main components that perform the processing of the normal model generation apparatus 1 including the calculator 113, the temporary storage 111, the storage 112, the input device 114, the transmitter-receiver 115, and the display 116 can be implemented with a common computer system, rather than with a dedicated system. For example, a computer program for performing the above operations may be stored in a non-transitory computer-readable recording medium such as a flexible disc, a compact disc read-only memory (CD-ROM), or a DVD-ROM for distribution, and may be installed on a computer to implement the normal model generation apparatus 1 that performs the above processing. In some embodiments, the computer program may be stored in a storage device included in a server device on a communication network such as the Internet, and may be downloaded by a common computer system to implement the normal model generation apparatus 1.

In a system with the above functions of the normal model generation apparatus 1 implementable partially by the operating system (OS) and partially by an application program or through cooperation between the OS and the application program, portions executable by the application program other than the OS may be stored in a non-transitory recording medium or a storage device.

The computer program may be superimposed on a carrier wave to be provided through a communication network. For example, the computer program may be posted on a bulletin board system (BBS) on the communication network to be provided through the communication network. The computer program may be activated and executed under the control of the OS in the same manner as another application program to perform the above processing.

In the above embodiment, the series of multiple modes included in each cycle section includes a predetermined number of modes in a predetermined order. In some embodiments, the order of the series of multiple modes included in each cycle section alone may be fixed. When, for example, the mode a is assigned to a section with the mode data generation method using FF-BS performed by the mode divider 12, the mode a or the mode b is assigned to a subsequent section. The series of multiple modes included in one cycle section includes one or more modes, and may include a different number of modes for each cycle section. The number and order of modes of the series of multiple modes included in one cycle section is hereafter referred to as a mode symbol string. The condition described below is added to the determination condition under which the cycle determiner 14 determines a cycle section to be normal. The condition to be added is that the mode symbol string of a cycle section matches a standard mode symbol string. The standard mode symbol string is, for example, a mode symbol string with the highest frequency of occurrence of the mode symbol strings included in the cycle sections.

In the above embodiment, steps S14 to S23 are repeated in the learning process illustrated in FIG. 10. In some embodiments, when the cycle data is already available in the second and subsequent cycles of learning, mode data may be generated by performing mode-division of the sensor data divided into cycle sections in step S14. In this case, the processing in steps S16 to S19 may not be performed until a predetermined release condition is satisfied. The predetermined release condition is that, for example, the mode data generated in step S14 is similar to existing mode data (the similarity is greater than or equal to a predetermined value) or when steps S14 to S23 have been repeated a predetermined number of times after the previous processing in steps S16 to S19. Using the same cycle data for a predetermined period as described above allows the template for the normal model to converge more easily. When the template converges to a certain degree, cycle sections are newly identified, and steps S14 to S23 are repeated. This increases the processing speed while increasing the accuracy of the normal model.

In the above embodiment, the mode divider 12 performs mode-division of the sensor data using the normal model. In some embodiments, when event signals from the operation subject are available, the mode divider 12 may perform mode-division of the sensor data based on the event signals.

In the above embodiment, the normal model generation apparatus 1 includes the sensor data acquirer 11, the mode divider 12, the cycle divider 13, the cycle determiner 14, the normal model generator 15, the normal model storage 16, the anomaly detector 17, and the output device 18. In some embodiments, the normal model generation apparatus 1 may simply include the sensor data acquirer 11, the mode divider 12, the cycle divider 13, the cycle determiner 14, and the normal model generator 15.

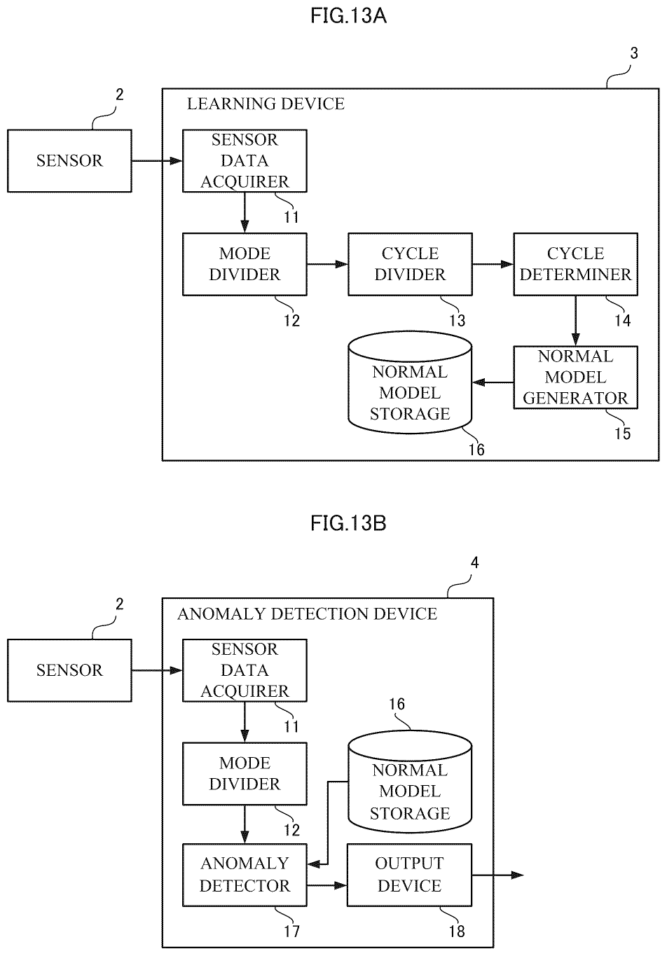

In the above embodiment, the normal model generation apparatus 1 includes the learning phase and the anomaly detection phase. In some embodiments, the normal model generation apparatus 1 may be implemented by a learning device that generates a normal model based on sensor data and an anomaly detection device that detects and outputs an anomaly based on sensor data. A learning device 3 and an anomaly detection device 4 in a modification are described with reference to FIGS. 13A and 13B.

As illustrated in FIG. 13A, the learning device 3 includes a sensor data acquirer 11 that acquires sensor data from the sensor 2, a mode divider 12 that generates mode data including the sensor data being divided by mode-division, a cycle divider 13 that generates, based on the mode data, cycle data indicating cycle sections in which a series of multiple modes is repeated, a cycle determiner 14 that determines a normal cycle section based on the cycle data and the mode data, a normal model generator 15 that generates a normal model based on the mode data included in the normal cycle section, and a normal model storage 16 storing the normal model.

As illustrated in FIG. 13B, the anomaly detection device 4 includes a sensor data acquirer 11 that acquires sensor data from the sensor 2, a mode divider 12 that generates mode data including the sensor data being divided by mode-division, a normal model storage 16 storing a normal model, an anomaly detector 17 that detects an anomaly for each section in the mode data based on the mode data and the normal model and generates anomaly detection data indicating sections in the mode data in which an anomaly is detected, and an output device 18 that outputs the anomaly detection data. The anomaly detection device 4 stores the normal model generated by the learning device 3 into the normal model storage 16.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Normal model generation apparatus
2 Sensor
3 Learning device
4 Anomaly detection device
11 Sensor data acquirer
12 Mode divider
13 Cycle divider
14 Cycle determiner
15 Normal model generator
16 Normal model storage
17 Anomaly detector
18 Output device
100 Anomaly detection system
111 Temporary storage
112 Storage
113 Calculator
114 Input device
115 Transmitter-receiver
116 Display
a to i Mode

1. A non-transitory computer-readable recording medium storing a normal model generation program executable by a computer for acquiring time series sensor data generated by a sensor detecting a state of an operation subject performing repetitive tasks including a series of plurality of modes, the program causing the computer to execute instructions comprising:
generating mode data including the sensor data being divided by mode-division:
generating, based on the mode data, cycle data indicating cycle sections in which the series of plurality of modes are repeated:
determining a normal cycle section based on the cycle data and the mode data; and
generating a normal model for each of the plurality of modes based on mode data included in the normal cycle section.

2. The recording medium according to claim 1, the program causing the computer execute instructions further comprising:
detecting an anomaly for each section in the mode data by comparing the mode data with the normal model and to generate anomaly detection data indicating a section in the mode data in which an anomaly is detected.

3. The recording medium according to claim 1, wherein
the generating of the mode data including generating, using the normal model including a template for each of the plurality of modes, the mode data by periodically assigning the series of plurality of modes to each section resulting from the sensor data being divided.

4. The recording medium according to claim 1, wherein
the generating of the cycle data includes detecting an inactive mode of the plurality of modes included in the mode data based on a length of a section of a mode or a change in values of the sensor data included in the mode, identifies a cycle section separated by end time of the inactive mode, and generates the cycle data.

5. The recording medium according to claim 1, wherein
until a predetermined learning end condition is satisfied, the generating of the mode data is repeated, the generating of the cycle data is repeated, the determining of the normal cycle section is repeated, and the generating of the normal model is repeated.

6. The recording medium according to claim 5, wherein
in repeated processing performed in the generating of the mode data, the generating of the cycle data, the determining of the normal cycle section, and the generating of the normal model,
when the cycle data is available, the cycle data is not generated in the generating of the cycle data until a predetermined release condition is satisfied.

7. The recording medium according to claim 5, wherein
in repeated processing performed in the generating of the mode data, the generating of the cycle data, the determining of the normal cycle section, the generating of the normal model,
when the cycle data is available, the mode data is generated in the generating of the mode data by performing mode-division of the sensor data divided into cycle sections indicated by the cycle data.

8. A normal model generation apparatus, comprising:
sensor data acquisition circuitry to acquire time series sensor data generated by a sensor detecting a state of an operation subject performing repetitive tasks including a series of plurality of modes;
mode division circuitry to generate mode data including the sensor data being divided by mode-division;
cycle division circuitry to generate, based on the mode data, cycle data indicating cycle sections in which the series of plurality of modes are repeated:
cycle determination circuitry to determine a normal cycle section based on the cycle data and the mode data; and
normal model generation circuitry to generate a normal model for each of the plurality of modes based on mode data included in the normal cycle section.

9. The normal model generation apparatus according to claim 8, further comprising:
anomaly detection circuitry to detect an anomaly for each section in the mode data by comparing the mode data with the normal model and generate anomaly detection data indicating a section in the mode data in which an anomaly is detected; and
output circuitry to output the anomaly detection data.

10. A normal model generation method implementable with a normal model generation apparatus for acquiring time series sensor data generated by a sensor detecting a state of an operation subject performing repetitive tasks including a series of plurality of modes, the method comprising:
generating mode data including the sensor data being divided by mode-division:
generating, based on the mode data, cycle data indicating cycle sections in which the series of plurality of modes are repeated:
determining a normal cycle section based on the cycle data and the mode data; and
generating a normal model for each of the plurality of modes based on mode data included in the normal cycle section.

11. The normal model generation method according to claim 10, further comprising:
detecting an anomaly for each section in the mode data by comparing the mode data with the normal model, and generating anomaly detection data indicating a section in the mode data in which an anomaly is detected.

12. The recording medium according to claim 2, wherein
the generating of the mode data including generating, —using the normal model including a template for each of the plurality of modes, the mode data by periodically assigning the series of plurality of modes to each section resulting from the sensor data being divided.

13. The recording medium according to claim 2, wherein
the generating of the cycle data includes detecting an inactive mode of the plurality of modes included in the mode data based on a length of a section of a mode or a change in values of the sensor data included in the mode, identifies a cycle section separated by end time of the inactive mode, and generates the cycle data.

14. The recording medium according to claim 3, wherein
the generating of the cycle data includes detecting an inactive mode of the plurality of modes included in the mode data based on a length of a section of a mode or a change in values of the sensor data included in the mode, identifies a cycle section separated by end time of the inactive mode, and generates the cycle data.

15. The recording medium-according to claim 2, wherein
until a predetermined learning end condition is satisfied, generating of the mode data is repeated, the generating of the cycle data is repeated, determining of the normal cycle section is repeated, and the generating of the normal model is repeated.

16. The recording medium-according to claim 3, wherein
until a predetermined learning end condition is satisfied, generating of the mode data is repeated, the generating of the cycle data is repeated, determining of the normal cycle section is repeated, and the generating of the normal model is repeated.

17. The recording medium-according to claim 4, wherein
until a predetermined learning end condition is satisfied, generating of the mode data is repeated, the generating of the cycle data is repeated, determining of the normal cycle section is repeated, and the generating of the normal model is repeated.

18. The recording medium according to claim 6, wherein
in repeated processing performed in the generating of the mode data, the generating of the cycle data, the determining of the normal cycle section, and the generating of the normal model,
when the cycle data is available, the mode data is generated in the generating of the mode data by performing mode-division of the sensor data divided into cycle sections indicated by the cycle data.
